(19) United States
(12) Patent Application Publication
(10) Pub. No.: US 2011/0082327 A1
(43) Pub. Date: Apr. 7, 2011

(54) SALINE MEMBRANOUS COUPLING MECHANISM FOR ELECTROMAGNETIC AND PIEZOELECTRIC ROUND WINDOW DIRECT DRIVE SYSTEMS FOR HEARING AMPLIFICATION

(76) Inventor: Manning Miles GOLDSMITH, Savannah, GA (US)

(21) Appl. No.: 12/897,903

(22) Filed: Oct. 5, 2010

Related U.S. Application Data
(60) Provisional application No. 61/249,345, filed on Oct. 7, 2009.

(51) Int. Cl. H04R 25/00

(52) U.S. Cl. 600/25; 381/326

(57) ABSTRACT

A system and method for electromagnetic or piezoelectric direct drive hearing amplification using a magnetic or piezoelectric oscillator attached to a saline implant coupled to the round window membrane and secured by a titanium or platinum ribbon.

### CROSS-REFERENCE TO RELATED APPLICATION

This application claims the benefit of U.S. Provisional Patent Application Ser. No. 61/249,345, filed Oct. 7, 2009, the entirety of which is hereby incorporated herein by reference for all purposes.

### TECHNICAL FIELD

The present invention relates generally to the field of treatments for hearing loss, and more particularly to surgically implanted direct drive devices using a magnetic or piezoelectric oscillator, attached to a saline implant which is coupled to the round window membrane and secured by a titanium ribbon.

### SUMMARY

The present invention relates to a direct drive system of hearing amplification using a saline implant coupled to the round window membrane and secured by a titanium ribbon. In an example embodiment, a sound processor 1 located within the external ear canal converts sound to an electromagnetic signal which is transmitted from an external coil 6 positioned close to the tympanic membrane (if present). The electromagnetic signal is transmitted across the tympanic membrane 16 and oscillates the magnet attached to 7, or within 11 the saline implant 2, and hence oscillates the outer membrane 8 of the implant 2 which abuts the round window membrane 15. This membrane oscillation creates a “reverse traveling wave” within the fluid medium of the scala tympani of the cochlea, thereby depolarizing the inner ear hair cells of the basilar membrane to create a sound percept.

In one aspect, the invention relates to a hearing amplification system including a sound processor for placement in an external portion of an ear to receive a sound and transmit a signal corresponding to that sound. The system further includes an implant having an implant membrane, a fluid contained within a fluid compartment bounded by the implant membrane, and an oscillator for oscillation in response to the signal transmitted from the sound processor. The fluid and the implant membrane form a coupling interface between the oscillator and a round window membrane of the ear.

In another aspect, the invention relates to a fluid membranous implant coupling mechanism for electromagnetic or piezoelectric direct drive systems to directly drive a round window membrane of an ear to achieve amplification for hearing impaired ears with a damaged middle ear mechanism. The implant coupling mechanism includes a fluid, an implant membrane containing that fluid, and an oscillator operatively coupled to drive the round window membrane through the fluid and the implant membrane.

In still another aspect, the invention relates to a malleable ribbon for coupling to a fluid membranous implant which a) directs energy of oscillation toward a juxtaposed membrane of the implant to a round window membrane, and b) provides an adjustable engagement of the round window membrane of the niche anteriorly with the wall of the middle ear posteriorly to secure the device.

In another aspect, the invention relates to a method of treating hearing loss. The method includes implanting a fluid membranous coupling in contact with a round window membrane of an ear. The fluid membranous coupling includes an oscillator, a fluid medium and an implant membrane. The method further includes placing a sound processor in an external portion of the ear to receive a sound and transmit a signal corresponding to that sound. The method further includes driving the oscillator in response to the signal transmitted by the sound processor to deliver energy to the round window membrane through the fluid medium and the implant membrane.

The present invention presents a simple saline implant coupling mechanism for both electromagnetic and piezoelectric direct drive systems which couples to the round window membrane and therefore does not require an intact tympanic membrane, any ossicular remnant, nor a complicated transmastoid surgical approach for installation.

### BACKGROUND

The auditory system is composed of the external, middle, and inner ear systems. The external ear is comprised of the auricle, or pinna, and the external ear canal. The middle ear is composed of the tympanic membrane, or eardrum, the middle ear space, and the three ossicles, or ear bones, which connect to the cochlea, or inner ear, via the oval window.

Sound is amplified by and transmitted through the external ear canal to the tympanic membrane. The sound is then further amplified by the middle ear complex whereupon the amplified sound is introduced through the oval window into the perilymphatic fluids of the scala tympani compartment of the cochlea. At this point, a so-called traveling wave is induced which oscillates the internal basilar membrane of the cochlea, thereby causing depolarization of the inner hair cells. The electrical currents generated by this depolarization of the inner ear cells are transmitted by the internal auditory neurons to the central nervous system where they are integrated and recognized as a sound percept.

When the external and/or middle ear conductive mechanism is damaged by pathology, the resultant hearing lost is termed “conductive.” When the inner ear and/or neural structures are damaged, the resultant loss is referred to as “sensorineural.”

Conductive losses can often be surgically restored by various procedures which reconstruct the damaged component(s) of the middle ear mechanism. For example, if the tympanic membrane has a perforation, this may be repaired, restoring the conductive hearing loss. Similarly, if the ossicles are disconnected or stiffened from pathologies such as chronic infection, they may be replaced by various manufactured prostheses. These prostheses either reconnect the disarticulated ossicular chain, or they replace a stiffened component of the ossicular chain, and in both instances restore vibratory conduction of sound through to the inner ear.

Generally, it is preferred that the natural middle ear mechanism be reconstructed when possible. It is desirable to have an intact barrier function of the tympanic membrane to prevent ear infections as well as to amplify the sound signal. Similarly, an aerated middle ear space with a mobile, connected ossicular chain provides the best scenario for amplified sound delivery to the inner ear.

However, in many instances the middle ear mechanism may not be reconstructed, particularly in the setting of chronic infections. Repeated infections or cholesteatoma may produce irreversible scarring within the middle ear and destruction of the ossicles. In these circumstances it may be impossible to achieve an intact tympanic membrane connected to the inner ear across an air containing, non-diseased middle ear.

So-called direct drive middle ear devices have been recently employed to transfer amplified sound energy directly to the ossicular chain, thereby bypassing damaged structures such as the tympanic membrane and ossicles. These direct drive systems are of two general types: piezoelectric and electromagnetic.

Generally, the piezoelectric devices work upon the principle that an electrical current, injected into a piezoelectric crystal will deform its shape. Similarly, if one deforms a piezoelectric crystal, it will emit an electrical current. This principle has been used to develop piezoelectric hearing systems which directly impart their amplified sound energies to the ossicular chain, thus bypassing the tympanic membrane and other damaged ossicles.

Electromagnetic direct drive systems impart their amplified sound energy directly to the ossicular chain via an attached magnet which receives its signal from an external sound processor. The external sound processor converts sound to an electromagnetic signal which is transmitted to an internal magnet attached to the ossicular chain. The internal magnet induces vibratory motion of the attached ossicle, which in turn transmits the amplified sound energy into the fluid of the inner ear.

Recently, an Italian otologist demonstrated that a vibratory direct drive implant placed in the round window niche could induce a “reverse traveling wave” into the perilymph fluids of the cochlea, or inner ear. That is to say, by oscillating the round window membrane, a traveling wave can be induced within the inner ear which oscillates the basilar membrane and depolarizes inner hair cells in much the same fashion as the aforementioned natural mechanism through the oval window. Thus, in damaged middle ears where the natural mechanism cannot be reconstructed, this alternative mechanism could be used to restore hearing. The present invention focuses upon an effective coupling system for direct drive systems to effectively engage the round window membrane in order to induce the reverse traveling wave.

### BRIEF DESCRIPTION OF THE DRAWINGS

FIG. 1 shows the three components of the proposed device: the sound processor 1; the implanted saline implant 2; and the platinum ribbon 3.

FIG. 2 shows an alternative embodiment of the saline implant 2, wherein the magnet 11 is internally attached to a diaphragm 13 within the saline implant. This internal oscillating unit may be a simple magnet, or, it may be a piezoelectric oscillating device.

FIG. 3 shows the position of the sound processor 1 and its external coil 6, in close approximation to the tympanic membrane 16. The saline implant 3 is depicted within the round window niche 15, inferior to the oval window and stapes 14.

FIG. 4 shows the mechanism of crimping the circumferential platinum ribbon 3, thereby elongating it and securing it between the round window niche 15 and the canal wall of the middle ear 19. This crimping mechanism causes the outer membrane of the device 8 to contact the round window membrane of the niche 15.

### DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

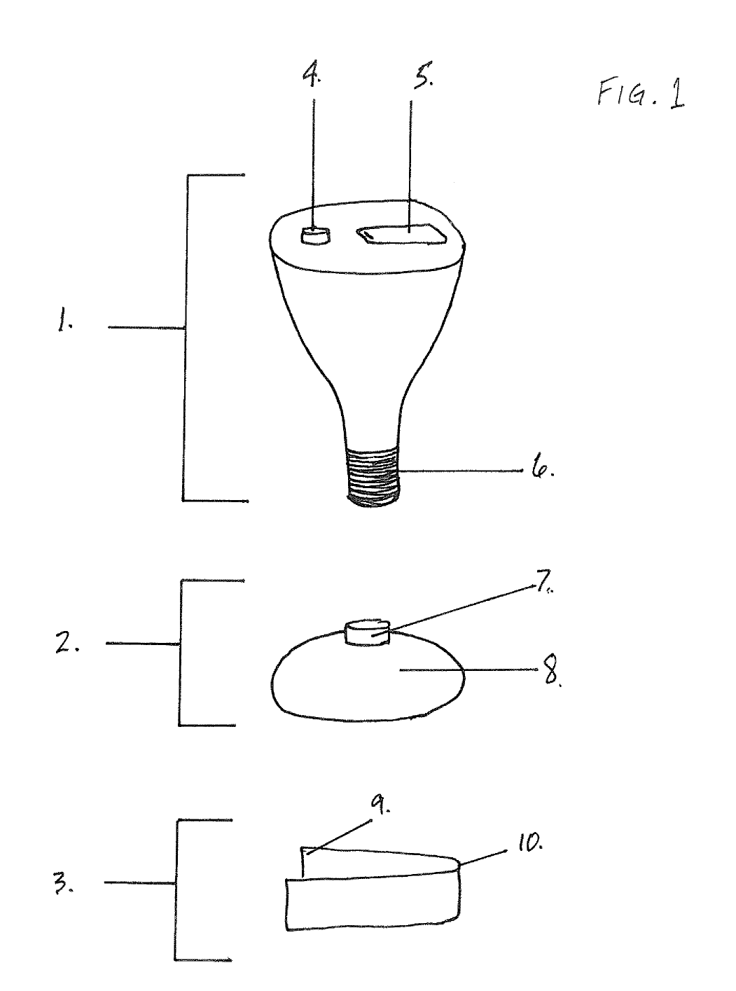

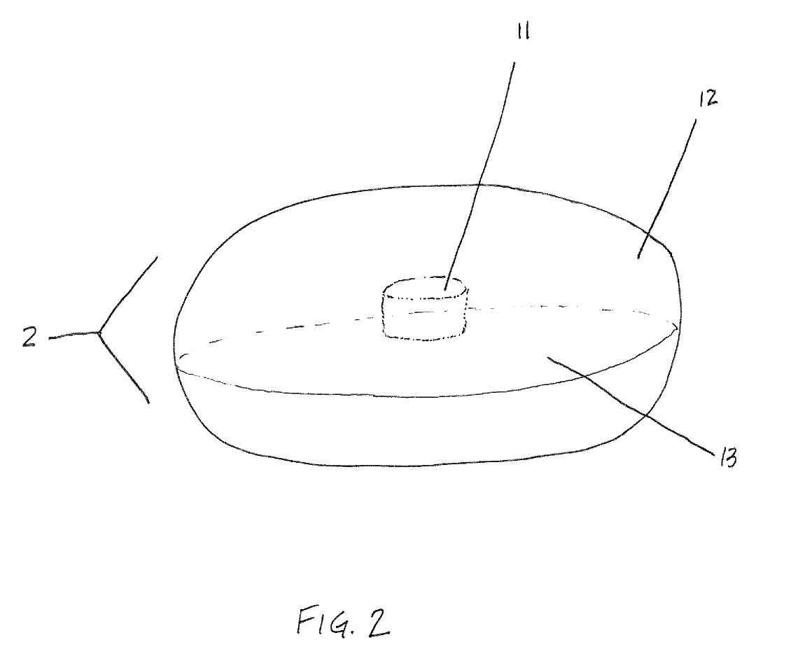

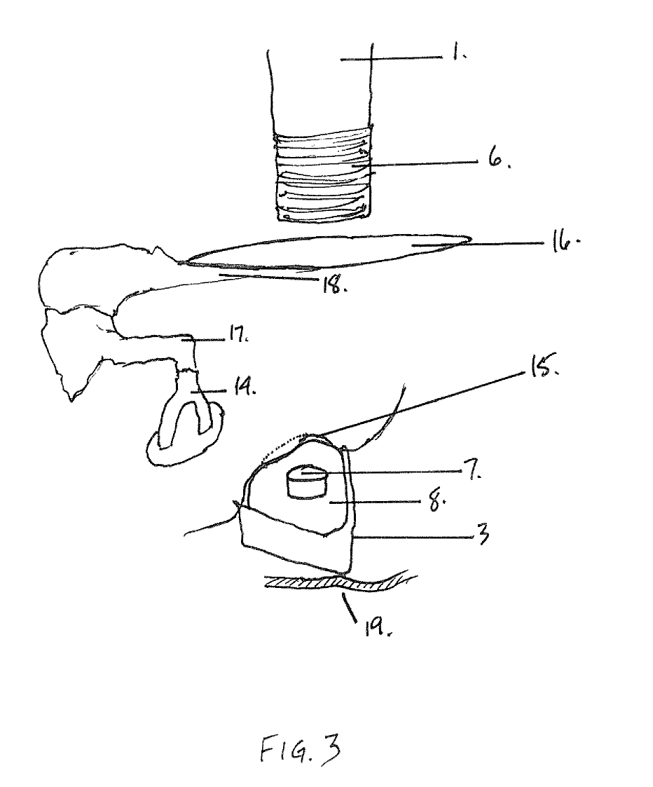

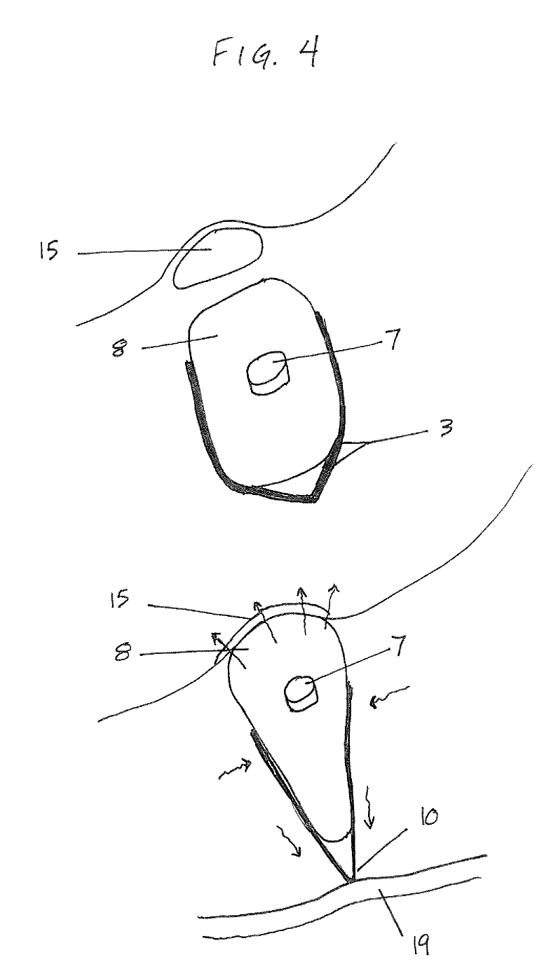

With reference to FIGS. 1-4, in an example embodiment of the invention a miniature saline implant whose estimated volume is 25-30 milliliters is coupled to a small magnet 7 and a separate semicircular malleable titanium ribbon 3. In one embodiment (FIG. 1) the magnet 7 is attached to the surface of the saline implant 8. In another embodiment (FIG. 2), the magnet is attached to a membranous diaphragm 13 within the saline implant 2, thereby suspending the magnet internally within the outer membrane 8 of the saline implant 2. This composite device is surgically implanted within the round window niche of the middle ear space. The magnet is oriented superiorly facing the tympanic membrane (if present) and parallel to the ear canal. The “bare” outer membrane surface of the saline implant is juxtaposed to the round window membrane.

The titanium ribbon surrounding the implant 3 is then crimped with crimping forceps, which elongates the device so that it may be secured in place from engagement of the titanium ribbon posteriorly 10 with the wall of the middle ear 19, while simultaneously protruding the bare membrane surface of the device anteriorly to engage the round window membrane and bony niche 15. The titanium ribbon 3 thus secures and elongates the device so that its bare membranous surface may engage the round window membrane, Importantly, the circumferential ribbon 3 also helps restrict membrane oscillation to the bare membrane 8 which engages the window 15.

The magnet of the device 7 is driven by an external electromagnetic coil 6 from a sound processor 1 located within the external ear canal. The external coil is positioned as closely as possible to the tympanic membrane (if present), but may be used if no tympanic membrane is present as well. The sound processor converts sound to an electromagnetic signal which is delivered across the tympanic membrane to the magnet of the implanted device. Oscillation of the magnet 7 imparts movement of the fluid compartment within the implant 2, whose membrane 8 is constrained by bone medially 19 and the ribbon circumferentially 3.

Thus the energy of oscillation is preferentially and primarily directed to that portion of the device membrane 8 that engages the round window membrane 15 within the niche. Movement of the round window membrane induces a “reverse traveling wave” within the perilymph fluids of the scala tympani of the cochlea. This traveling wave displaces the basilar membrane which in turn causes the depolarization of its associated inner hair cells, producing the electrical percept of sound.

While the invention has been described with reference to preferred and example embodiments, it will be understood by those skilled in the art that a variety of modifications, additions and deletions are within the scope of the invention, as defined by the following claims.

What is claimed is:

1. A hearing amplification system comprising:
a sound processor for placement in an external portion of an ear to receive a sound and transmit a signal corresponding to said sound; and
an implant comprising an implant membrane, a fluid contained within a fluid compartment bounded by the implant membrane, and an oscillator for oscillation in response to the signal transmitted from the sound processor;
wherein the fluid and the implant membrane form a coupling interface between the oscillator and a round window membrane of the ear.

2. The hearing amplification system of claim 1, further comprising a ribbon for holding a portion of the implant and retaining a surface of the implant membrane in engagement with the round window membrane of the ear.

3. The hearing amplification system of claim 2, wherein the ribbon comprises a material selected from titanium, platinum and combinations thereof.

4. The hearing amplification system of claim 2, wherein the ribbon comprises a malleable strip having first and second ends engaging opposed sides of the implant, and a medial portion between the first and second ends defining an apex for abutment against a middle ear wall.

5. The hearing amplification system of claim 2, wherein the ribbon is crimped onto the implant to form an elongate assembly.

6. The hearing amplification system of claim 1, wherein oscillation of the oscillator imparts movement to the round window membrane and induces a reverse traveling wave in the inner ear to produce a percept of sound.

7. The hearing amplification system of claim 1, wherein the oscillator comprises a magnetic oscillator, and the sound processor transmits an electromagnetic signal.

8. The hearing amplification system of claim 1, wherein the oscillator comprises a piezoelectric oscillator, and the sound processor transmits an electronic current signal.

9. The hearing amplification system of claim 1, wherein the fluid comprises saline.

10. A fluid membranous implant coupling mechanism for electromagnetic or piezoelectric direct drive systems to directly drive a round window membrane of an ear to achieve amplification for hearing impaired ears with a damaged middle ear mechanism, said implant coupling mechanism comprising a fluid, an implant membrane containing said fluid, and an oscillator operatively coupled to drive the round window membrane through the fluid and the implant membrane.

11. The implant coupling mechanism of claim 10, further comprising a ribbon member having a first ribbon portion for engagement with the implant membrane and a second ribbon portion for engagement with a wall of the middle ear to position the fluid membranous implant coupling mechanism at the round window membrane.

12. The implant coupling mechanism of claim 11, wherein the ribbon member comprises a material selected from titanium, platinum and combinations thereof.

13. The implant coupling mechanism of claim 11, wherein the first ribbon portion comprises first and second fingers engaging opposed sides of the implant membrane therebetween, and the second ribbon portion comprises a medial portion between the first and second fingers and defining an apex for abutment against a middle ear wall.

14. The implant coupling mechanism of claim 13, wherein the ribbon member is crimped onto the implant to form an elongate assembly.

15. The implant coupling mechanism of claim 10, wherein the oscillator is a magnetic oscillator.

16. The implant coupling mechanism of claim 10, wherein the oscillator is a piezoelectric oscillator.

17. A malleable ribbon for coupling to a fluid membranous implant which a) directs energy of oscillation toward a juxtaposed membrane of the implant to a round window membrane, and b) provides an adjustable engagement of the round window membrane of the niche anteriorly with the wall of the middle ear posteriorly to secure the device.

18. The malleable ribbon of claim 17, comprising a material selected from titanium, platinum and combinations thereof.

19. A method of treating hearing loss comprising:
implanting a fluid membranous coupling in contact with a round window membrane of an ear, the fluid membranous coupling comprising an oscillator, a fluid medium and an implant membrane;
placing a sound processor in an external portion of the ear to receive a sound and transmit a signal corresponding to said sound; and
driving the oscillator in response to the signal transmitted by the sound processor to deliver energy to the round window membrane through the fluid medium and the implant membrane.

20. The method of claim 19, further comprising engaging the fluid membranous coupling implant with the round window membrane by attaching a biocompatible metal ribbon to a portion of the implant, and securing the ribbon in engagement posteriorly with a wall of the middle ear while simultaneously protruding a portion of the implant membrane anteriorly to engage the round window membrane.

21. The method of claim 20, further comprising crimping the metal ribbon to elongate the implant.
